(19) United States
(12) Patent Application Publication
(10) Pub. No.: US 2002/0055892 A1
(43) Pub. Date: May 9, 2002

(54) Personalized sales video system

(76) Inventors: Eric Brown, Newport Beach, CA (US); Wen Chung Cheng, La Palma, CA (US)

Correspondence Address: Patent Law & Venture Group, Suite K-105, 3151 Airway Ave., Costa Mesa, CA, 92626, US

(21) Appl. No.: 09/971,161

(22) Filed: Oct. 4, 2001

Related U.S. Application Data
(60) Provisional application No. 60/237,886, filed on Oct. 4, 2000.
(60) Provisional application No. 60/070,521, filed on Jan. 6, 1998.
(60) Provisional application No. 60/071,623, filed on Jan. 16, 1998.
(60) Provisional application No. 60/088,727, filed on Jun. 10, 1998.
(60) Provisional application No. 60/188,059, filed on Mar. 9, 2000.

(51) Int. Cl. G06F 17/60

(52) U.S. Cl. 705/27

(57) ABSTRACT

A video sales program compilation method, especially useful in the sales industry, comprises the steps of displaying customer information on a computer monitor screen; selecting a sales customer from a list of sales customers on the screen; displaying plural product pictures on the screen; displaying one selected product from the plural product pictures; displaying related product elements on the screen; selecting from the related product elements; displaying the one product with the related product elements on the screen; calculating a payment schedule for purchase of the one product and the related product elements; creating at least one graphic slide for the one product alone and for the one product with at least one of the related product elements as a combination and for the payment schedule; downloading the at least one graphic slide including a purchase selection element as a sales email message to the sales customer; and receiving an acceptance of the purchase selection element by the customer as a response to the sales email message.

The present invention claims the priority date of a prior filed provisional patent application having Ser. No. 60/237,886 and an official filing date of Oct. 4, 2000 and which discloses substantially identical matter as described herein.

Related applications: No. 60/070,521 filed Jan. 6, 1998, No. 60/071,623 filed Jan. 16, 1998, No. 60/088,727 filed Jun. 10, 1998, Ser. No. 09/225,173 filed Jan. 4, 1999, Ser. No. 09/266,647 filed Mar. 11, 1999, Ser. No. 09/322,209 filed May 28, 1999 and No. 60/188,059 filed Mar. 9, 2000.

### BACKGROUND OF THE INVENTION

1. Field of the Invention

This invention relates generally to automated selling methods and more particularly to a method used for creating a video sales presentation especially useful in the medical care field.

2. Description of Related Art

The following art defines the present state of this field:

Beller et al., U.S. Pat. No. 5,961,446 describes a teleconferencing system using video conferencing between a nurse station and a patient station to deliver medical care. The patient station is programmed to contain customized instructions concerning medications, procedures, or visitations that were placed there by the nurse. The customized audio, video and text information transforms the patient station into a highly personalized information source, which can be reviewed by the patient when the unit is off line. Medical procedures and medications are also programmed into the patient station by the nurse to remind the patient of all scheduled events, including visitations. A record of medical compliance is stored in the patient station, which record is uploaded to the nurse station and compared to the original event schedule. In such manner, the patient station is an intelligent personal medical assistant, programmed by the nurse to provide customized reminders and information necessary for the efficient management of the patient's illness. The patient station is easy to use, including only four large buttons which are re-definable by notations on a video screen, and, for the convenience of the patient, the video camera at the patient station is remotely controlled by the nurse to obtain the desired view without requiring that the patient move.

Chen et al, U.S. Pat. No. 6,249,281 teaches the use of miniature images of slides to navigate through the playback of a presentation. Selecting one of the miniature images allows the video playback portion of the presentation to fast forward, or reverse, to the corresponding portion of the video message.

The prior art teaches the use of sales techniques, wide area communications networks, data creation, transmission, storage, retrieval, and display, but does not teach a sales and promotion method capable of selective sales video creation for distance selling to a single customer or to a group of customers with a common interest. The present invention fulfills these needs and provides further related advantages as described in the following summary and detailed description. Further, the prior art does not teach the creation of immediate on-demand video messaging to customers.

### SUMMARY OF THE INVENTION

The present invention teaches certain benefits in construction and use which give rise to the objectives described below.

A video sales program compilation method, especially useful in dealing with those that are home-bound or at a distance from the product or service provider, such as home care patients or business customers located far from a supplier, comprises the steps of displaying customer information on a computer monitor screen; selecting a sales customer from a list of sales customers on the screen; identifying the relevant interests of the sales customer, displaying plural product pictures on the screen; displaying one selected product from the plural product pictures; displaying related product elements on the screen; selecting from the related product elements; optionally displaying the one product with the related product elements on the screen; optionally calculating a payment schedule for purchase of the one product and the related product elements; creating at least one graphic slide for the one product alone and, optionally, for the one product with at least one of the related product elements as a combination and for the payment schedule; uploading the at least one graphic slide including a purchase selection element as a sales email message to the sales customer; and optionally receiving an acceptance of the purchase selection element by the customer as a response to the sales email message. The uploading process includes the unique features of automatically recording, storing, encoding, and synchronizing the video portion of the video prior to automatically uploading the corresponding data files to a centralized server that streams the videos to customers on-demand. Users of the system include the End-User, a consumer or student or patient or family health care giver. The Presenter is a person who represents a business or its affiliated or related interests, in using the system. Typically, this person would be a sales representative who is guiding a sales process with the ultimate goal of closing the a sale. However, this person could also be a technical support representative providing assistance with a device or process or similar, or this person could be a coach or trainer providing instruction or education to an End-User.

A primary objective of the present invention is to provide an apparatus and method of use of such apparatus that provides advantages not taught by the prior art.

Another objective is to provide such an invention capable of automating a sales process.

A further objective is to provide such an invention capable of selling to distant customers via a wide area data transmission network.

A still further objective is to provide such an invention capable of being managed closely without manual supervision.

Other features and advantages of the present invention will become apparent from the following more detailed description, taken in conjunction with the accompanying drawings, which illustrate, by way of example, the principles of the invention.

### BRIEF DESCRIPTION OF THE DRAWINGS

The accompanying drawings illustrate the present invention. In such drawings:

FIG. 1 is a block diagram of the preferred embodiment of the invention;

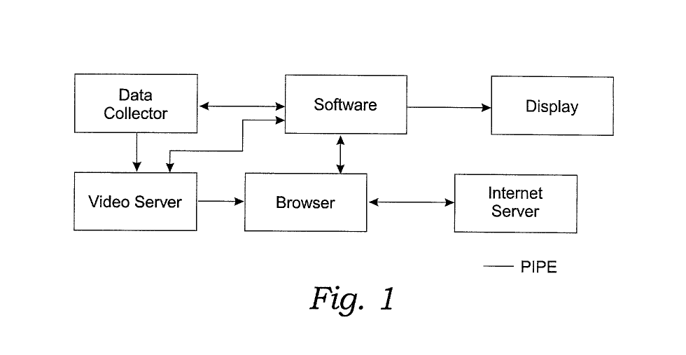

FIG. 2 is a flow diagram showing a first embodiment of the method of use thereof; and

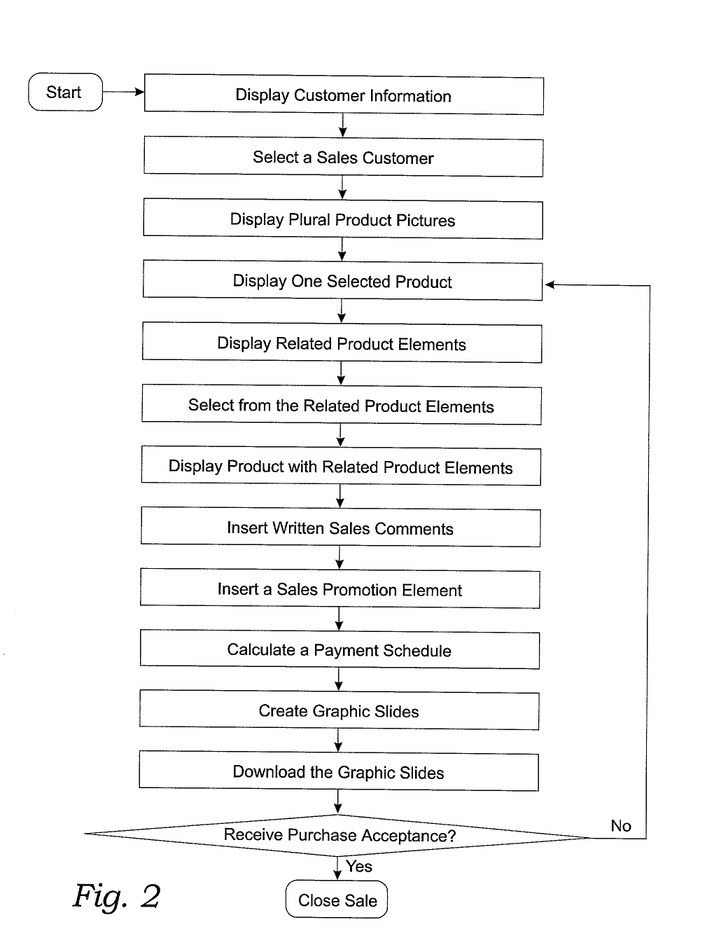

FIG. 3 is a further flow diagram showing a second embodiment of the method of use thereof.

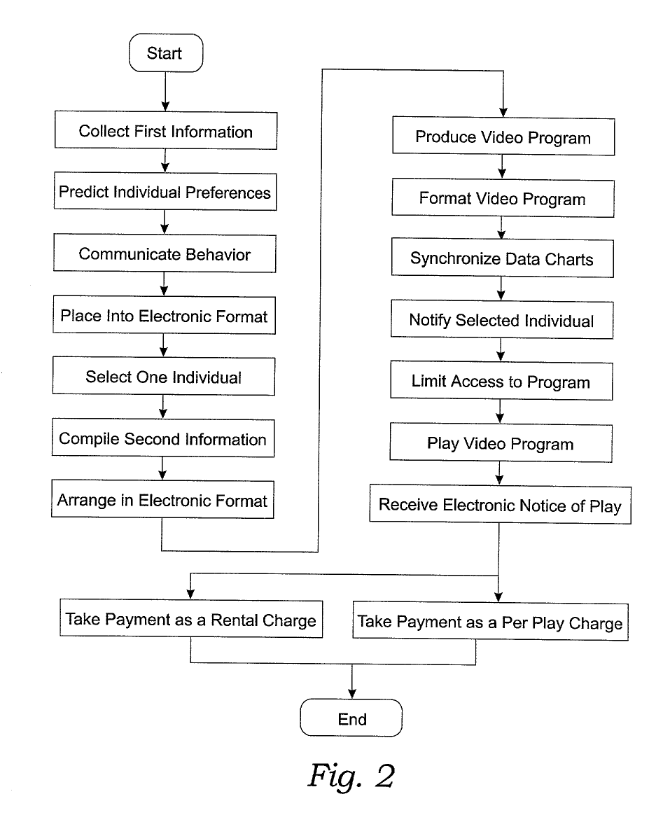

### DETAILED DESCRIPTION OF THE INVENTION

The above described drawing figures illustrate the invention in at least one of its preferred embodiments, which is further defined in detail in the following description.

The Personalized Sales Video System comprises personal data collecting devices (Data Collectors). The Data Collectors may include, for example, wave-energy enabled devices which monitor behavior, information formats, such as those that might be presented on a computer screen for data entry, observational systems such as computer instruction sets or programs that monitor database or internet traffic for changes or for finding information, other software enabled systems for determining commercial or personal information, such as purchase process status, e.g., is a consumer seeking product options, or has the consumer decided to buy a particular model and is only seeking a best price, or is the consumer ready to purchase at the offered price but needs to be finally urged to make the purchase, or other such purchase process dynamic status variables. These wave-energy devices are described more thoroughly in related applications: No. 60/070,521 filed Jan. 6, 1998, No. 60/071,623 filed Jan. 16, 1998, No. 60/088,727 filed Jun. 10, 1998, Ser. No. 09/225,173 filed Jan. 4, 1999, Ser. No. 09/266,647 filed Mar. 11, 1999, Ser. No. 09/322,209 filed May 28, 1999 and No. 60/188,059 filed Mar. 9, 2000. The Data Collectors may also include data entry methods, such as the creation of shopping lists based upon an item desired by the consumer, Internet-enabled browsers (Browser) such as Microsoft Internet Explorer or Netscape Navigator or Mosaic. The Browser may include any Internet-enabled viewing system for text, graphics or a combination of the two. The Data Collectors may also include an information server for database storage and manipulation (Database) such as Microsoft® SQL Server a well known and regarded computer database structure and system. Further, the Data Collectors may include any inference algorithms which are commonly used to predict consumer behavior such as, for example, algorithms which relate date of birth to gender, geographic location, economic status, and previous purchases on credit cards.

### Exemplary Architecture

The system further may comprise a video server means for streaming video images and audio tracks (Video Stream) such as Microsoft Media Server® or Real Networks Video Server®. An Internet server means (Internet Server) is used for sending HTML web pages and other formats of Browser-viewable pages over the internet. An Internet connection means (also referred to as a Pipe) links the Browser, Database, Video Stream and Internet Server with each other and with other Internet users. Preferably, the Pipe has high-bandwidth such as a the well known Ti line, cable modem or DSL approaches. However, ordinary dial-up modems are also sufficient although they function more slowly. Server operating systems such as Windows NT® or Windows 2000 or Unix ® (Server Operating System) is advantageously employed. Depending upon the capabilities of the Server Operating System and the underlying hardware platform, the Database, Video Stream and Internet Servers may reside on the same machine or may reside on several machines that are linked with the Pipe or alternate linking means. End-user operating systems such as Windows 95®, Windows 98®, Windows NT®, Windows ME®, or Windows 2000® are preferably employed in the present invention. However, other operating systems such as Unix® or Linux® may alternately be used. All such operating systems are collectively referred to here as the User Operating System. Video camera or other video capture devices and microphones or other sound capture devices for creating custom videos may be employed. Preferably, the video cameras have parallel or USB connections to a desktop personal computer. The microphone, preferably, links to a sound card or similar circuitry within this personal computer. However, the use of integrated camera/microphones and other formats of cameras and microphones may also be used. Collectively the video capture device and sound capture device are referred to herein as the Camera. An important part of the system are personal computers, such as Pentium II® and Pentium III® based PCs that are commonly available with viewing monitors, keyboards, mouse, speakers and other typical accessories and these are collectively referred to herein as the PC. However this is not a limitation of the invention and the use of older or newer PCs may occur. Also, specialized video creation software (Video Software) for generating custom videos, including controls for recording and setting camera and microphone functions are used. Such Video Software also replays videos after creation and compresses videos for distribution to others using the Video Stream. Means for transferring data from Data Collectors to the Database are used. Such means may include the use of Internet-based forms, physical devices which monitor the behavior of the consumer, or other devices including, but not limited to, devices which receive wave-energy signals from Data Collectors. The data from Data Collect is then stored with related or corresponding information in the Database. The method of sending the information to the Database includes formatting it for transfer via the Pipe and this is well known.

The system also includes a means for creating graphical representations of data from the Database, typically in the form of illustrations, pictures, time plots and charts. Preferably, multiple graphic representations are shown and synchronized for comparative viewing during the video presentation. The data stored in the Database may include data that is transferred from the Data Collectors. It may also include data that is received from other sources, such as a catalog of products and their affiliated purposes, or a listing of daily interest rates for consumer products, or the daily rate for leasing consumer products such as automobiles. It may further include data that is received from other sources which describes a process or series of steps to perform to accomplish a goal. Any and all such graphical representations are referred to as the Charts.

The system also includes a means for accessing and graphically viewing pictures of products or illustrations of tangible items or illustrations of process-oriented steps or illustrations representing intangible products, such as a mortgage with a corresponding interest rate, as may be stored on the Database. An example of such a process are the steps necessary to prepare a meal, including making a list of items to procure, preparing the items for cooking, instructions for cooking times, and illustrations of serving suggestions. Another example of such a process are the steps necessary to sell an automobile. These sale closing steps include illustrations of the vehicle and related accessories, colors or other options, graphical charts of loan or lease rates, comparative charts of competing vehicles or financing rate options, and other such charts as is usual and customary for the closing of a sale. Any and all such graphical representations are included when we refer to the Charts.

The system also includes a means for hearing sound from the audio track of the Video Stream, such as an audio speaker or headphone, a means for seeing moving pictures from the Video Stream such as a projector and screen or a video monitor, a means for determining personalized information from the Database as may apply specifically to a selected end-user, and a means for selecting graphical images from a large database and placing them in a list of selected Charts for later use in random, sequential or repetitive order.

The system also includes a means for creating a video in a window on a screen while selecting the graphical images from a list. Such images appearing in an adjacent window may be synchronized with a video message mentioning or describing such graphical image.

The system provides a means for automatically creating a relationship between personalized information about the End-User and the graphical images generated from the Database and the text format data from the Database and provided to the Presenter. For example, the business rules which drive an SQL database provide the means for determining which Charts are offered for display or would be most likely to be used or selected by the Presenter during production of a message to the End-User. Text or a visual message that cues the Presenter to mention appropriate portions of the personalized information in synchronization with selecting the Charts are enabled for display.

The system is enabled for automatically generating a script or list of points for the Presenter to mention. Such means includes running pre-defined rules on the database to identify-End-Users who are likely to benefit from such information. For example, the management at an automobile dealership might decide that all customers that month would receive a special discount. Likely customers requiring a discount prior to purchase could then be identified automatically from the database and this list provided to the Presenter with a graphic describing the discount.

Similarly, the Presenter may simply wish to go through his list of potential customers sequentially. In such an application, the system automatically provides the Presenter with the graphical Charts that relate to each individual customer. For example, in an auto dealership, the Data Collectors may identify that a customer is interested in a sports utility vehicle or SUV. When the Presenter accesses this customer or End-User, the system automatically provides the Presenter with related information and Charts on the two models of SUV at the auto dealership and not information and Charts on the other models. In this manner, the Presenter may have the relevant information to close the sales provided to him prior to making the video presentation and thereby allowing him to focus his time and attention on rapidly addressing the End-User and not waste time sorting through inappropriate information. In another such example, a Presenter representing a medical supply firm may use the invention to identify an End-User with diabetes and is automatically provided with Charts corresponding to relevant medical supplies for this End-User. In this example, the Data Collectors may identify when refills are needed and which type of medication is required, thereby allowing the Presenter to have the relevant information and needs of this End-User identified prior to making the presentation. The Presenter is more efficient because he does not have to sort through thousands of different medications and medical supplies to find the Charts corresponding to the needs of the End-User.

The system is enabled for automatically generating Charts, such as a shopping list or purchasing order form. Such Charts may be generated based upon running pre-defined rules on the database, for example discount coupons on competitive brands such as a coupon for a different brand of aspirin when the Data Collectors indicate that a refill is required or a different brand of automobile tire when the Data Collectors indicate that a certain mileage has likely been reached.

The system is enabled for allowing the Presenter to review the Charts and personalized information and then take notes for items to mention to the End-User in a video presentation consisting of the Video Stream and synchronized Chart displays. Such notes may optionally be displayed to the End-User.

The system is enabled for reviewing; including linking to either an internal database of customer notes or an outside program for customer relationship management, such as Goldmine®, and viewing or editing the customer notes.

The system is enabled for allowing the Presenter to review the Charts and personalized information and then to prepare notes to be displayed to the End-User in a video presentation consisting of the Video Stream and synchronized Chart displays. One or more such Charts would include the display of such notes created by the Presenter.

The system is enabled for generating information that is of temporal use to the End-User, including presentation of such information in text, graphical or video formats. Such temporal information may be in the form of Alerts or Suggestions. The Alerts might include information about a data parameter that is of interest, such as a special discount being offered to value-minded End-Users. The Suggestions might include purchasing suggestions for upcoming holidays or events, such as a suggestion to purchase a 4-wheel drive vehicle prior to winter. These Alerts and Suggestions are able to be displayed to the End-User. These Alerts and Suggestions are also displayed to the Presenter prior to creation of a Video Stream. The Alerts and Suggestions are one form of automatically generated scripting information.

The system is enabled for automatically or manually creating a notification to the End-User that the Presenter has completed a video message with synchronized Charts to be shown at the convenience of the End-User. Such notification method means includes, but is not limited to, sending the End-User an e-mail which contains a link that can be selected. Selecting the link then brings up the Browser window in which the video message with synchronized Charts appears. The e-mail message may be generated manually or automatically or a combination. Similarly, the video message may automatically or manually play within the e-mail message, but this embodiment is not as desirable because it requires greater bandwidth and cost to distribute these messages.

At the option of the Presenter, the system is enabled for allowing multiple End-Users to receive a copy of the same video message with synchronized Charts. For example, in an automobile dealership, the Data Collectors can be used to identify all customers requiring an oil change and single video message with synchronized Charts may be sent to all these End-Users. In another example, in a health care supply firm, a single video message may be sent to all End-Users requiring a medication refill, as determined by the Data Collectors.

The system is enabled for producing custom prepared videos with associated and synchronized chart presentations which can be made using commonly available software such as Microsoft Netshow or Real Networks Real Presenter. However, the drawbacks of these products include an inability to link directly to databases, a time consuming and expensive method of preparation and delivery, and an inability to randomly select charts while in the midst of creating the video. Also, these products lack the ability to automatically generate scripts for the person creating the video. Furthermore, these products do not automatically identify which Charts are appropriate to a particular End-User.

As an example of the method of use of the foregoing system, a sales manager for a department or dealership has already used the system administrator pages to authorize a sales representative (rep) to have access. The sales rep will have access only to the customers authorized as (i) this rep's personal customers and (ii) the “sales group” for this rep. A sales manager my use a portion of a cold call list as a sales group, or he may use the list of customers for a single dealership in a multi-dealership business, or he may use a grouping in other ways. The system administrator functions are not detailed here, but they allow the sales manager to push pop-up messages to any or all of the reps; make customer notes by group or individual; and other top-down sales push incentives. This push function allows management to bring specials and deals to the attention of the reps as they might apply to a deal pitch. The system administrator features are fairly extensive and will not be detailed in this Overview document.

A Customer Record Page is divided into two large vertical boxes. On the left is a scrollable list of customer names. A button above this list toggles between “My Customers” and “All Customers in My Group.” The list of customers allows one name to be highlighted at a time using a mouse. On the right is a similar sized vertical box divided into three sections. Each of the three sections has an individual vertical scroll bar. When a customer name on the left is highlighted, the box on the right shows recent shopping events or activity for this customer, such as which make and model, customer data such as contact info, spouse name, important dates, etc., and sales rep notes such as notes that may have been written after an earlier meeting or phone call.

Each field in these boxes is linked to the Database. In addition, they may also be linked to a dealership CRM system or to an individual sales rep CRM tool such as Goldmine. Any updates, notes, comments, changes, etc. made in boxes 1, 2 or 3 automatically update the appropriate database and CRM tools.

The sales rep picks a customer that he wants to pitch and hits a “Continue” button at the bottom of the screen. A Create Pitch Page is divided into four primary boxes. On the top left is a scrollable list of graphics and financing terms. Next to this box are buttons entitled “Accessories”, “Car Pictures”, “Close Deal”, and “Discount/Financing Terms.” On the bottom left is a display box which shows whatever is selected from the above list. On the top right are the sales rep notes as described above. This box is also interactive and allows the notes to be changed and the appropriate databases to get updated. On the lower right is a display box labeled “Deal Points.” Any sentences typed here are automatically turned into bullet points for a custom deal pitch.

The sales rep has already selected a customer. Now he uses this page to create his pitch. The Data Collectors indicate that this customer is interested in a “BMW 740”. The Charts for this model appear as pictures in the box below. The “accessories” for this model also appear and he picks pictures for “chrome wheels” and an “upgraded audio system”. As he presses these buttons, the images for the wheels and stereo automatically appear in the box below. The database knows which model wheels and stereo to use based upon the vehicle model. The sales rep presses “Discount/Financing” and selects “36-month lease no accessories” and “36-month lease option 2 with accessories”. He also sees a pop-up message from his sales manager that says “any BMW 740 sale closed in the next 48 hours gets a $500 bonus gift certificate for the customer and $500 cash for the sales rep”. So he selects “instant $500 bonus certificate”. The database automatically calculates the lease options with current rates for that day. The sales rep does not have to do any manual computations. The sales rep has pointed with the mouse and clicked nine times so far. We target fewer than 12 clicks to create the pitch. Now the sales rep rereads the notes about the customer. He sees that the customer mentioned liking gourmet food and wine in their last conversation. He now clicks on the box called “Deal Points” and begins typing: “$700/month for new car $18/month extra for chrome wheels $12/month extra for audiophile system. Buy today and get $500 gift certificate at the local Wine Cellar.”

He clicks on “continue” and goes to the next page. The software system of this invention automatically creates a JPEG graphic slide for each selected item including pictures, lease charts and deal points. As an option, the system can also create HTML graphics that have clickable links to other pages or popups.

In training nurses to use a nearly identical page for a medical care help application, we found that most people mastered the creation page in about 15 minutes. After mastering this page, most people created presentations in about 60 seconds. It's very intuitive and most people seem to know what they want to show and say before they begin recording because they have been provided with the relevant consumer information and therefore, do not have to focus on finding such information from a vast collection of imagery.

A Record Pitch Page has one large box for the graphic slide images and one scroll box with the list of the JPEG graphic slides across the middle of the page. In the upper left is a small box that displays the video camera image of the sales rep. In the upper right are customer and product identification information, and an elapsed time counter. In the lower left is a “Record” button that toggles into a “Stop” button. The sales rep is now ready to create his closing pitch to the customer. The images may appear as clickable miniature sized pictures or text that correspond to the image to be contemporaneously displayed. He clicks on “740 image” and it appears in the display box. This will be his opening image. After he clicks “record” he will begin talking and clicking on the other image names. Whenever he clicks on an image, it will be synched to appear at that exact moment in his audio pitch. He can click on an image more than once if he wants it to reappear, such as beginning and ending his pitch with a picture of the car. The sales rep makes a pitch to buy the car, the upgraded accessories that only cost $30/month more on the lease, aid ends by offering the customer a $500 gift certificate to any local store, such as a wine store, if he acts by a deadline date. He watches the elapsed timer to keep it under 90 seconds. The sales rep clicks “stop” and the video is done. He clicks “continue” to go to the next page. In training of both health care professionals and others on the similar CareHelper.com page, we found that most people mastered this page in about 5 minutes and described the video creation as fun. After mastering the page, most videos were created in under 60 seconds. A “Playback and Deliver” page is used to allow the sales rep to review his pitch and decide whether to revise the video or deliver it to the customer. If he hits the “playback” button, the page transforms to show a small video box and a large flipchart box. The video plays and the Charts flip in synch with the audio track. If he hits the “deliver” button, the customer name and e-mail address pop up. There is a window for a text message to be delivered with an e-mail notification. The sales rep types “Bob, I've got a special deal for you. Click on the link below and the details will be explained. Take care and thanks for your business. Sincerely, Willie”. In an enhanced version of the software, this page comes up with a list of templates for e-mail text messages. The templates have a pre-determined message which includes variables that automatically fill-in the corresponding information for Presenter, End-User, Subject, and message body.

The sales rep hits the send button and moves to the beginning to prepare for another customer.

The message sent is received by the customer as an e-mail message appearing in the customer's in-box from the sales rep. Bob, the customer, opens the e-mail and reads the text message from Willie. At the bottom of the e-mail is a link that can be pressed. The link has lots of code numbers and letters in it. The customer presses the link and his web-browser automatically opens to a secure page with dealer logo branding. Simultaneously, a message automatically is sent to our server that logs the viewing time of the user and enters it into the CRM and database software. The server then sends an e-mail viewing notice to the sales rep and, optionally, sends a text message to the sales rep's pager which includes the telephone number of the recipient and the time of viewing. The customer page has a large graphics window and a video window. A floating pop-up download bar automatically appears that says “Loading Special Video Message from Willie for Bob”. Depending upon modem speed, the bar is completed in 15-90 seconds. Then the video begins playing automatically and the image charts begin flipping in sync with the audio track. On this page are also buttons that say “Buy Now—No Accessories”, “Buy Now—with Accessories”, “Not Now, Keep in Touch” and “Replay”. If he presses a buy button, he will be brought to a pre-filled lease contract with pricing and a credit card payment screen. If he presses “Not Now” then a canned thank you, message is displayed. There is also a box where the customer can type a message to be sent back to the sales rep. Since the sales rep has received a pager notification of this viewing event, he uses his discretion as a sales professional to time his follow-up with the customer.

The “Replay” button is self-explanatory. The system has the ability to log whatever buttons the customer presses and when he presses them.

The Sales Station is the PC workstation that a Presenter uses to access the Database and create the Video Stream. The “Data Collector” are web-based forms which link to the “Database”. The Browser also allows the End-User to create, view, access, modify and otherwise interact with a Shopping List Manager, previously disclosed, or with an internet-based car buying website. This is another form of a Data Collector in which information is collected from the End-User regarding personal shopping habits or desires. The Alerts, Suggestions, Reminders, Shopping List information, Database information, and Charts formed from the Database information all are enabled to appear on the Sales Station screens. The Presenter is able to select any or all of these items, in any order including repeating any items, while creating the Video Stream. These are then saved, compressed and displayed to the End-User in sync with the video message after the End-User opens an e-mail with a selectable link. Such Video Stream message include purchasing or inventory status information, reminders to make purchases, reassurance, rapport-generating statements, educational information, financing information and/or other information or commentary as may be deemed advisable by the Presenter to close the sale. Samples of such video commentary were previously disclosed in the above mentioned patent applications.

The preferred embodiment described herein describes examples of using the invention for automobile sales applications. It should be noted, however, that the technology can just as easily be applied to applications outside of auto sales and no limitation on usage is implied. For example, the System could be used with a healthy consumer undergoing a diet and exercise program. The Data Collectors would measure body fat, calories burned, distance walked, and body weight. The shopping list would include diet bars and powders. A fitness consultant, rather than a sales representative, would be the Presenter. The fitness consultant would recommend new exercises, provide encouragement and support, and suggest purchases of appropriate nutritional supplements. The End-User would use the Browser to receive this information, including Video Streams from the fitness consultant with selected synchronized charts. In another example, the System could be used with a consumer looking to purchase cruise ship tickets or automobiles. The Data Collectors would include forms about their interest in different destinations or vehicle models. The Charts would include images of different destination, accommodations, vehicle features, and/or financing options for the trip or vehicle purchase.

In such a manner, the invention disclosed herein, which is based on technology previously disclosed, has application in many fields including health, fitness, diet, nutrition, travel, and consumer purchases.

Likewise, the invention has applications in many forms of business-to-business relationships. For example, the System could be used by sales representatives for companies selling integrated circuits and electronic components to manufacturers of electronic devices. The Presenter would be the sales rep of the component provider. The End-User would be the purchasing agent of manufacturer. The Data Collection devices would include the manufacturer's inventory database system. The Video Stream would include data about needed components including Charts which illustrated products, showed graphical representations of inventory usage or status, and automatically generated purchase order forms for the End-User to approve. In this manner, in all fields of business and commerce, the described invention offers a low-cost method by which status-reporting and sales-generating data can be deployed to the purchasers of products.

From the foregoing it is clear that the method of the present invention may be further described as follows:

A video sales program compilation method comprising the steps of displaying customer information on a computer monitor screen; selecting a sales customer from a list of sales customers on the screen by judging from the customer information which customer is likely to make a purchase; displaying plural product pictures on the screen; displaying one selected product from the plural product pictures whereby the selected product is judged to be a likely match to the selected customer; displaying related product elements on the screen such as options, accessories, add-ons and the like; selecting from the related product elements those that might be likely to add to the sales potential of the product; displaying the one product with the related product elements on the screen in a manner that provides a compelling sales possibility; calculating a payment schedule for purchase of the one product and the related product elements to provide an acceptable set of choices to the customer and one that is likely to be accepted; creating at least one graphic slide for the one product alone and for the one product with at least one of the related product elements as a combination and for the payment schedule to produce a compelling visual and audible sales presentation; downloading the at least one graphic slide including a purchase selection element as a sales email message to the sales customer; and receiving an acceptance of the purchase selection element by the customer as a response to the sales email message. If a sale is not consummated, the presentation may be considered as a trial and revised to meet the objections of the customer until a sale is made. Clearly, written sales comments may be inserted into the sales email message as described above. Further, a sales promotion element may be inserted into the sales email message. The email or other electronic communication may be fitted with a streaming video or other live-action video presentation.

The above method is carried-out with an apparatus for producing a video sales program comprising at least the elements of a Data Collector, a Browser, a Video Server, an Internet Server and a Pipe, the Pipe enabled for interconnecting the elements for intelligent signal transfer as is described in detail above. A software means is enabled for collecting storing, manipulating and selecting data and for creating graphical and audible representations or Charts of the data, and for visual and audible displaying of the data on a display means. Such software is available, as stated above, in the commercial marketplace and also may be customized for use in the present method. A means for transmitting the visual and audible displays of the data via wave energy transmission are well known in the art.

While the invention has been described with reference to at least one preferred embodiment, it is to be clearly understood by those skilled in the art that the invention is not limited thereto. Rather, the scope of the invention is to be interpreted only in conjunction with the appended claims.

What is claimed is:

1. A video sales program compilation method comprising the steps of: displaying customer information on a computer monitor screen; selecting a sales customer from a list of sales customers on the screen; displaying plural product pictures on the screen; displaying one selected product from the plural product pictures; displaying related product elements on the screen; selecting from the related product elements; displaying the one product with the related product elements on the screen; calculating a payment schedule for purchase of the one product and the related product elements; creating at least one graphic slide for the one product alone and for the one product with at least one of the related product elements as a combination and for the payment schedule; downloading the at least one graphic slide including a purchase selection element as a sales email message to the sales customer; and receiving an acceptance of the purchase selection element by the customer as a response to the sales email message.

2. The method of claim 1 including the further step of inserting written sales comments in the sales email message.

3. The method of claim 1 including the further step of inserting a sales promotion element in the sales email message.

4. The method of claim 1 including the further step of inserting a live-action video presentation in the sales email message.

5. An apparatus for producing a video sales program comprising: the elements of a Data Collector, a Browser, a Video Server, an Internet Server and a Pipe, the Pipe enabled for interconnecting the elements for intelligent signal transfer; software means enabled for collecting storing, manipulating and selecting data and for creating graphical and audible representations or Charts of the data, and for visual and audible displaying of the data on a display means; and a means for transmitting said visual and audible displaying of the data via wave energy transmission.

6. A video sales program compilation method comprising the steps of:
a) collecting a first information about a group of individuals using an electronic collection process for placing the first information in an electronic format;
b) selecting one individual from the group of individuals in accordance with a selection criterion;
c) compiling a second information from the first information, the second information corresponding to the selected individual;
d) arranging the second information as text and graphics in the electronic format, the graphics comprising at least one of a plurality of data charts;
e) producing an electronic video program from the second information;
f) formatting the video program for playback, including synchronization of the at least one data charts;
g) notifying the selected individual of how to remotely access the video program for viewing through an electronic process;
h) playing the video program when requested by the selected individual; and
i) receiving an electronic notice when the video program is played by the selected individual.

7. The method of claim 6 further comprising the step of using data collectors to determine preferences of each individual in the group of individuals.

8. The method of claim 6 further comprising the step of using data collectors to predict preferences of each individual in the group of individuals.

9. The method of claim 6 further comprising the step of using data collectors to communicate behavior of each individual in the group of individuals.

10. The method of claim 6 further comprising the step of limiting access to the video program to only the selected individual.

11. The method of claim 6 wherein the process of step (g) is completed using Internet data transfer.

13. The method of claim 6 wherein the notice of step (i) is transferred using an electronic paging process.

14. The method of claim 6 further comprising the step of taking payment for completing steps (a) through (g).

15. The method of claim 14 wherein the payment is calculated as a combination of a rental charge against time plus a use based on a per viewing by the selected individuals.

16. The method of claim 6 further comprising the step of taking payment from the selected individual after completing steps (a) through (i).
